(19) United States
(12) Patent Application Publication
(10) Pub. No.: US 2008/0230532 A1
(43) Pub. Date: Sep. 25, 2008

(54) TORTILLA OVEN

(76) Inventors: Austin J. Kozman, Dallas, TX (US); Jose G. Ramirez, Rio Medina, TX (US)

Correspondence Address: MICHAEL A. O'NEIL, P.C., 5949 SHERRY LANE, SUITE 820, DALLAS, TX, 75225, US

(21) Appl. No.: 12/051,041

(22) Filed: Mar. 19, 2008

Related U.S. Application Data
(60) Provisional application No. 60/896,027, filed on Mar. 21, 2007.

(51) Int. Cl. F27B 9/06

(52) U.S. Cl. 219/388

(57) ABSTRACT

A tortilla oven comprises a housing which encloses upper, center, and lower conveyors. The lengths of the conveyors are individually monitored and adjusted. The interior of the housing is heated by a plurality of the individually regulated burners that extend through the conveyors. Ambient air is directed upwardly along the sides of the housing for temperature control.

### CLAIM TO PRIORITY

Applicant claims priority based on provisional patent application Ser. No. 60/896,027 filed Mar. 21, 2007, the entire content of which is incorporated herein by references

### SUMMARY

This application discloses and claims an automated tortilla baking oven.

### DESCRIPTION OF THE DRAWINGS

FIG. 1 is a perspective view of a tortilla oven comprising the present invention:

FIG. 2 is a top view of the tortilla oven of FIG. 1;

FIG. 3 is a left end view of the tortilla oven of FIG. 1;

FIG. 4 is a view similar to FIG. 1 showing the construction of the frame of the tortilla oven of FIG. 1;

FIG. 5 is a front view of the tortilla oven of FIG. 1 from which various doors have been removed in order to illustrate particular components of the invention;

FIG. 6 is a perspective view similar to FIG. 4 to which the input section and the discharge section of the tortilla oven have been added;

FIG. 7 is a perspective view of the input section of the tortilla oven;

FIG. 8 is a perspective view of the discharge section of the tortilla oven;

FIG. 9 is an exploded view of the input section of the tortilla oven;

FIG. 10A is a sectional view of the tortilla oven taken along the line 10A-10A in FIG. 2;

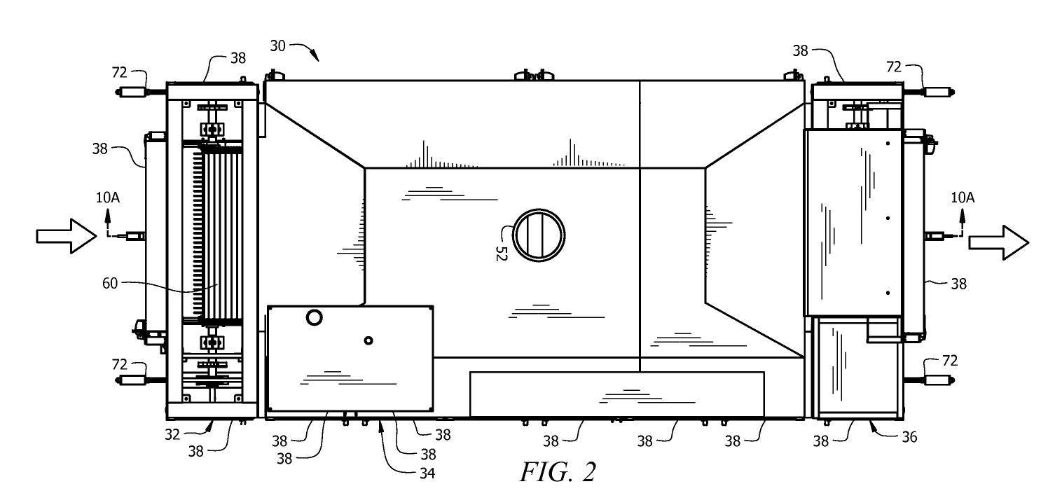

FIG. 2B is an illustration of a first chain tensioned monitoring device comprising the tortilla oven.

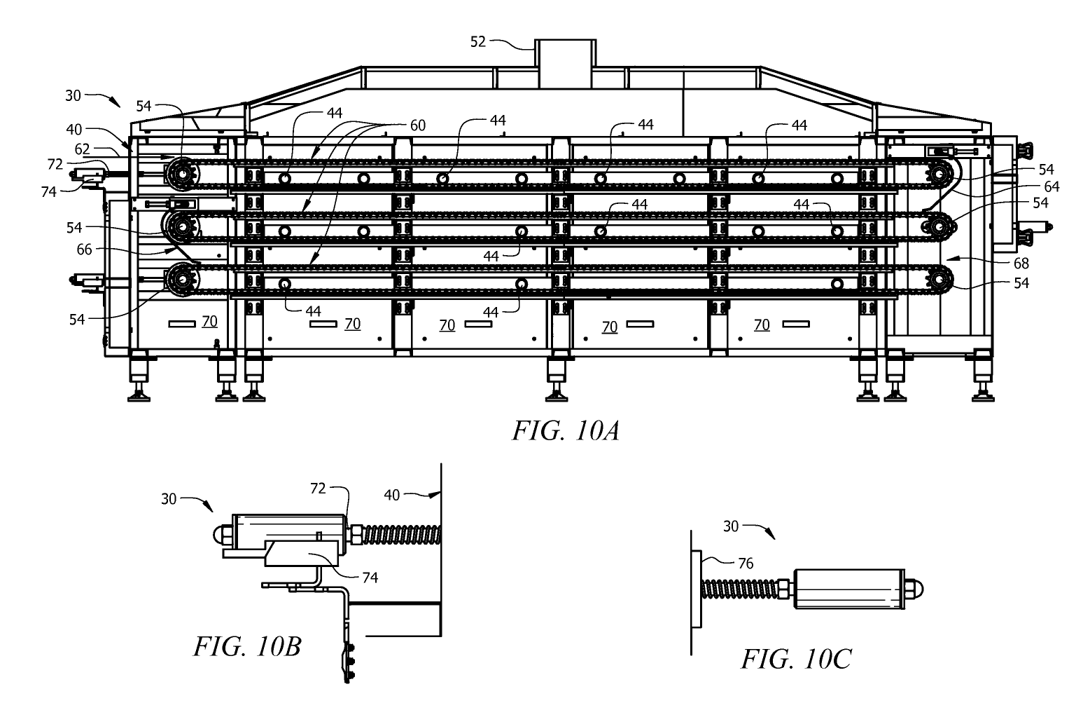

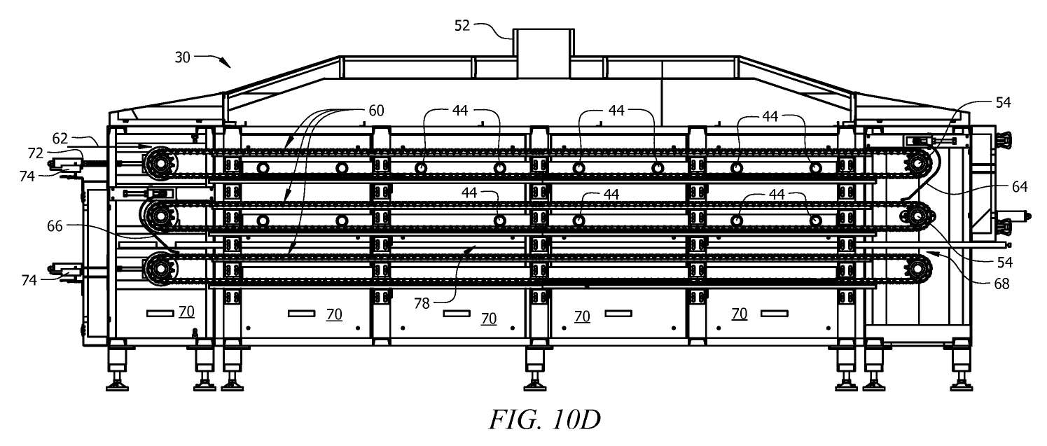

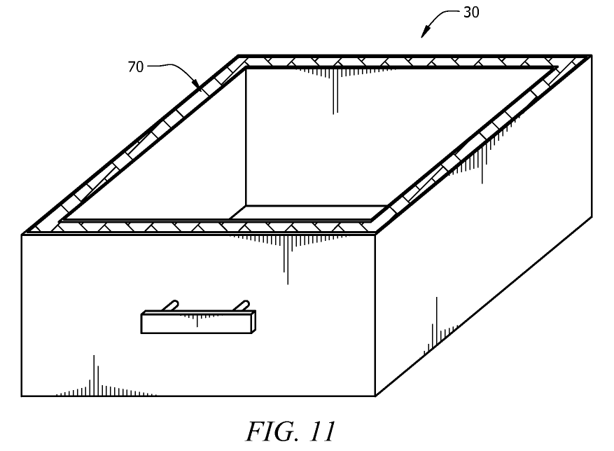

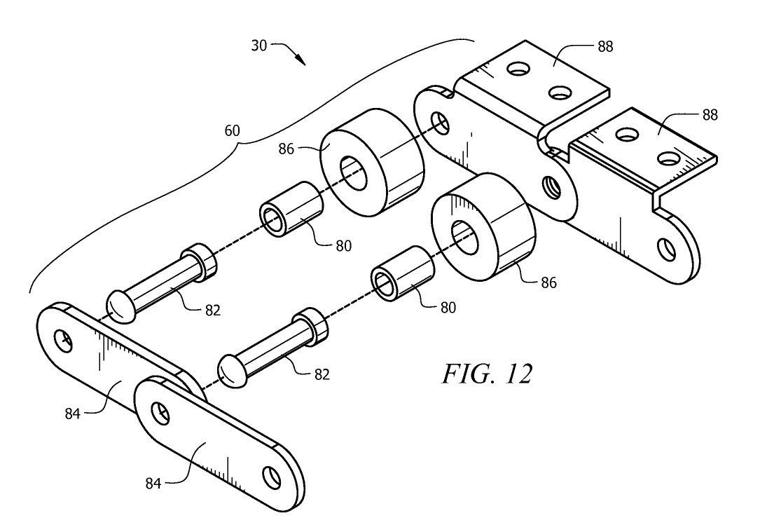

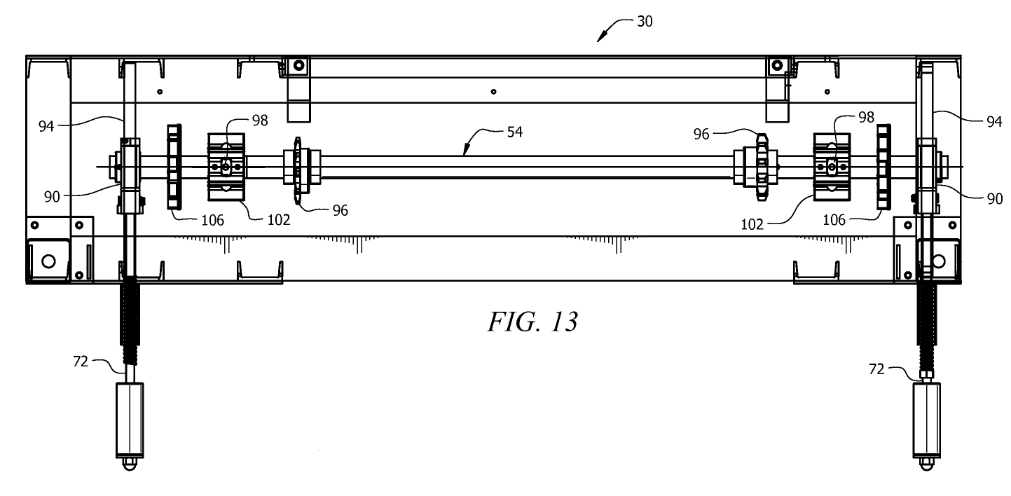

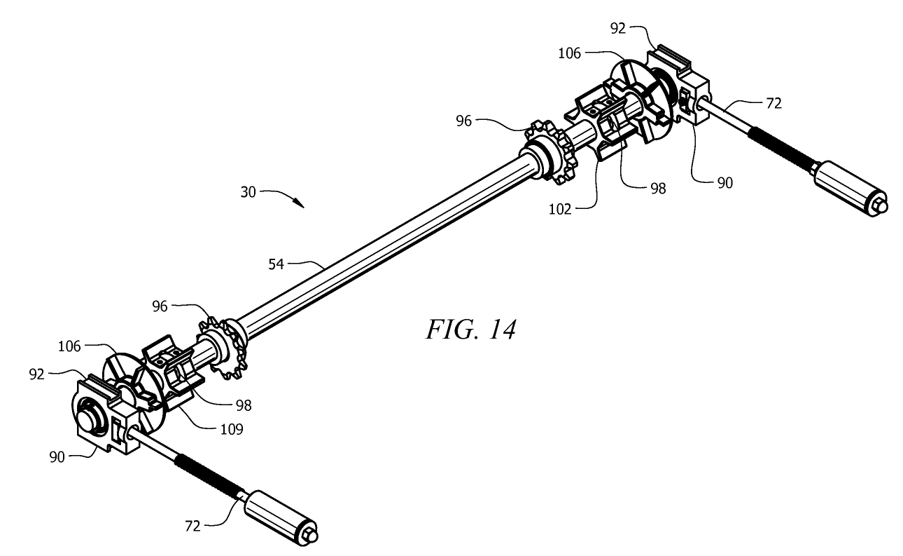

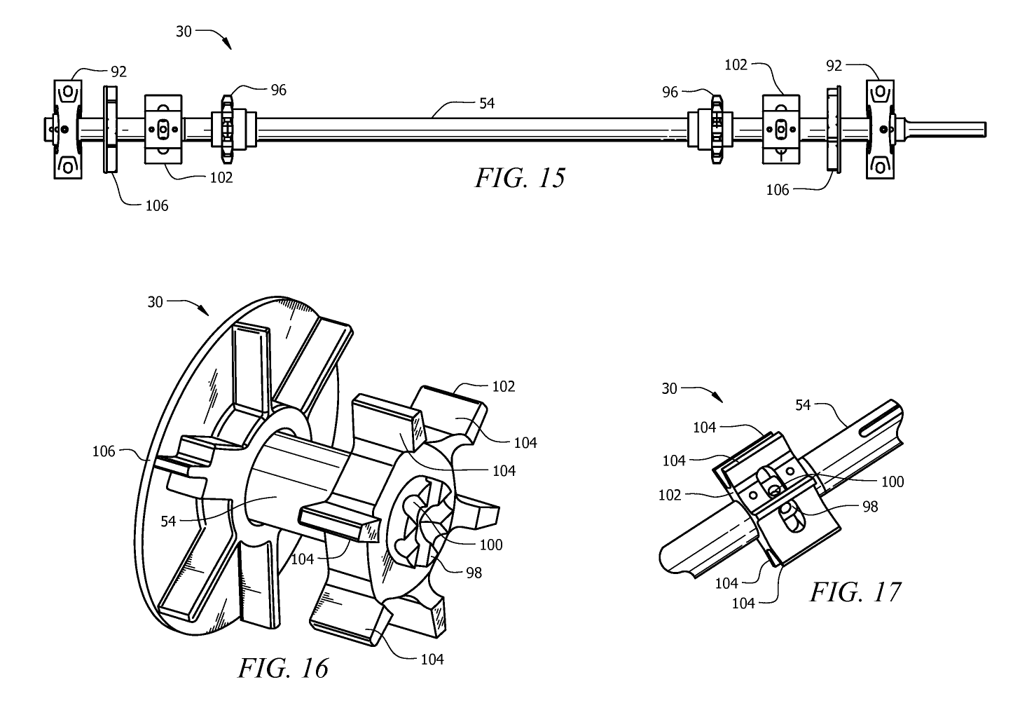

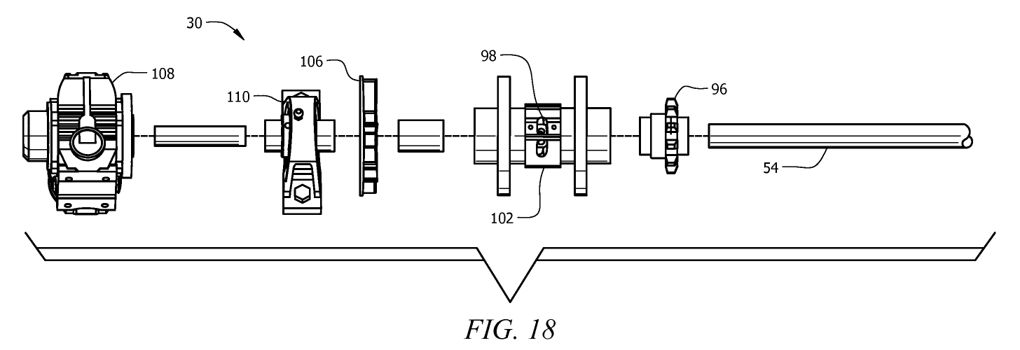

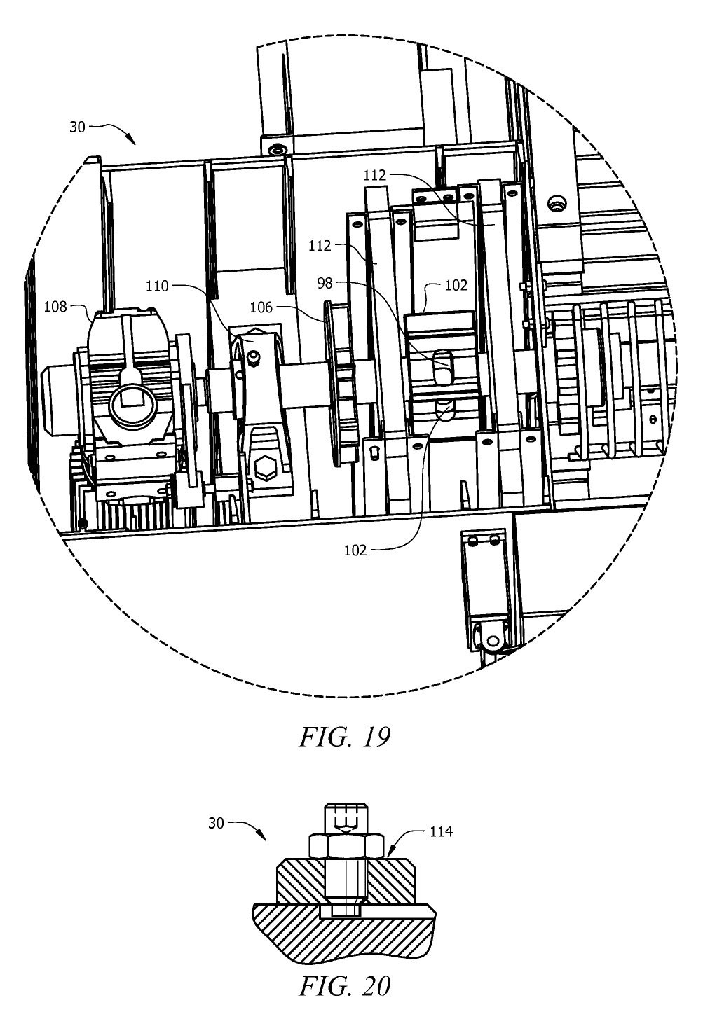

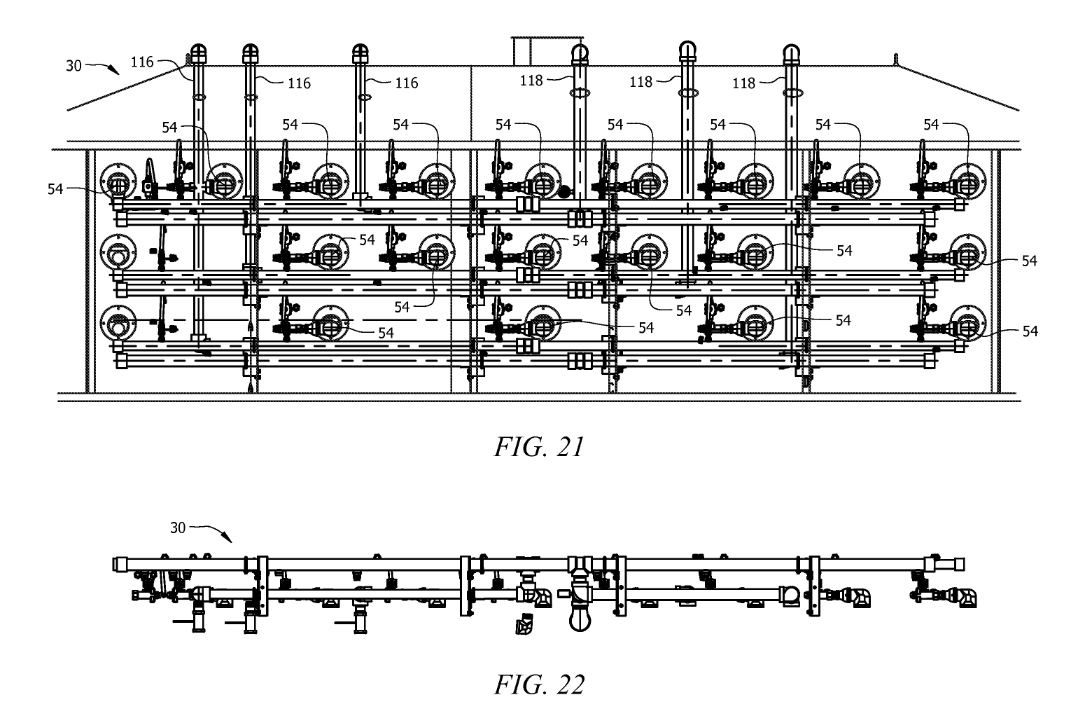

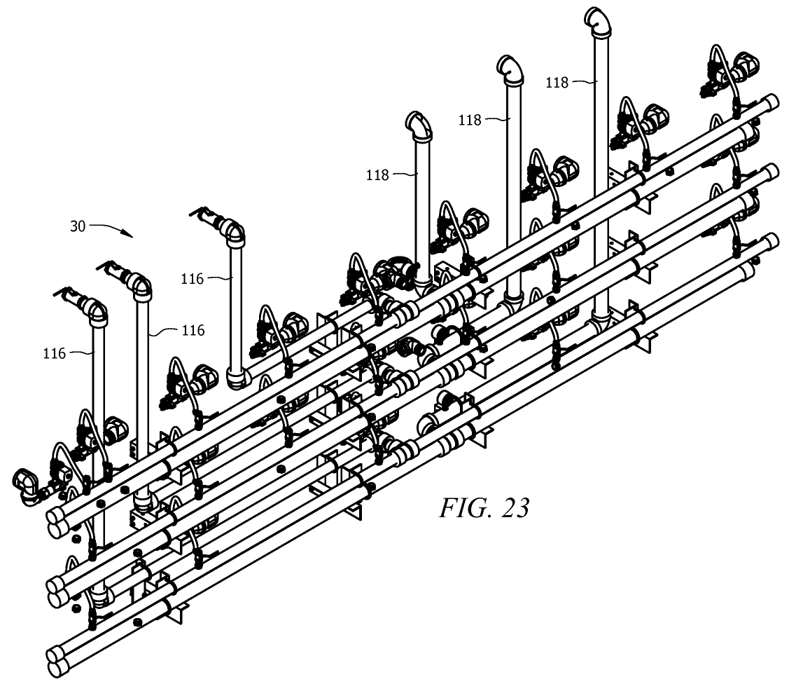

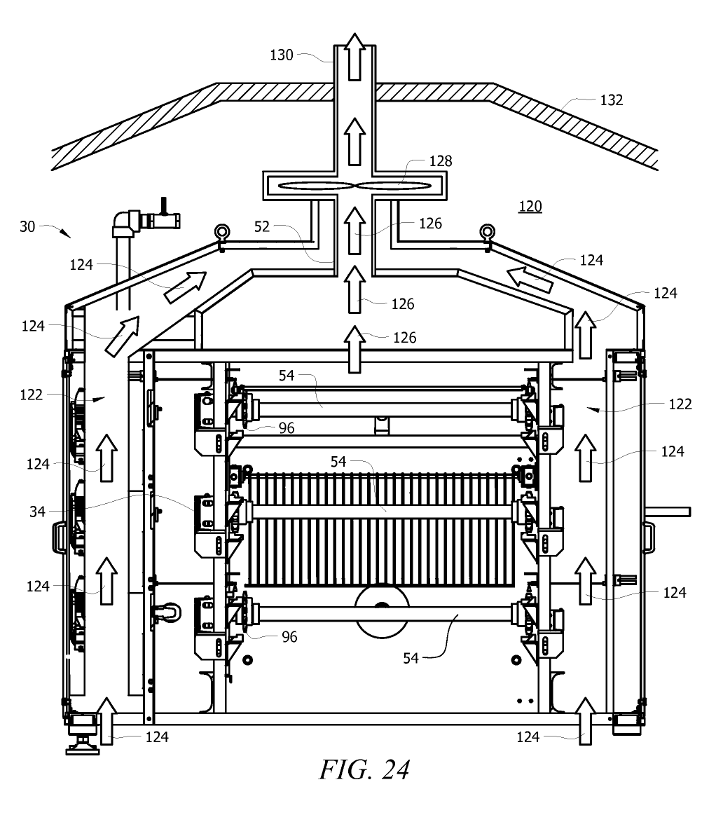

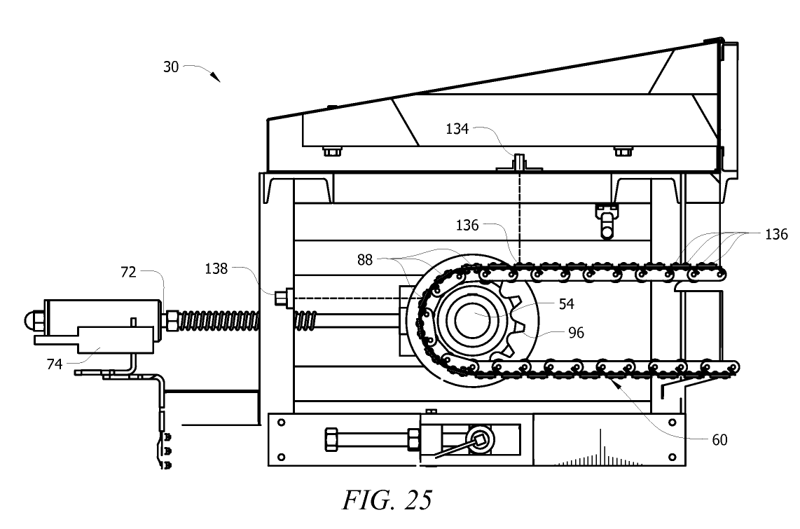

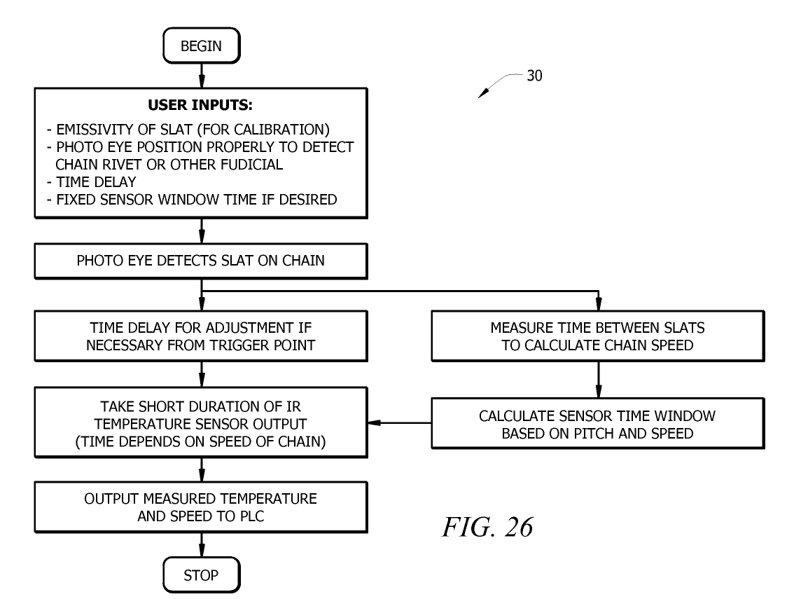

FIG. 10C is an illustration of a second chain tension monitoring device comprising the tortilla oven;

FIG. 10D is sectional view similar to FIG. 10A illustrating an alternative configuration of the tortilla oven;

FIG. 11 is a perspective view of a debris receiving drawer comprising the tortilla oven;

FIG. 12 is a perspective view illustrating the construction of the chain of the tortilla oven;

FIG. 13 is top view illustrating the construction of the drive shafts of the tortilla oven;

FIG. 14 is a perspective view further illustrating the construction of the drive shaft of the tortilla oven;

FIG. 15 is a further illustration of the construction of the drive shafts of the tortilla oven;

FIG. 16 is an enlarged partial perspective view illustrating certain components of the drive shafts of the tortilla oven;

FIG. 17 is a partial perspective view further illustrating the construction of certain components of the drive shafts of the tortilla oven;

FIG. 18 is an exploded view further illustrating the construction of the drive shafts of the tortilla oven;

FIG. 19 is an illustration of one end of one of the drive shafts comprising the tortilla oven;

FIG. 20 is sectional view illustration a component of the drive shaft illustrated in FIG. 19;

FIG. 21 is a side view of the tortilla oven illustrating the construction and operation of the burner assemblies of the tortilla oven;

FIG. 22 is a top view further illustrating the construction and operation of the burner assemblies of the tortilla oven;

FIG. 23 is perspective view further illustrating the construction and operation of the burner assemblies of the tortilla oven;

FIG. 24 is an illustration of a temperature control system and of an exhaust gas removal system comprising the tortilla oven;

FIG. 25 is an illustration of a chain temperature monitoring system comprising the tortilla oven; and

FIG. 26 is a flow chart illustrating the operation of the chain temperature monitoring system of FIG. 25.

### DETAILED DESCRIPTION

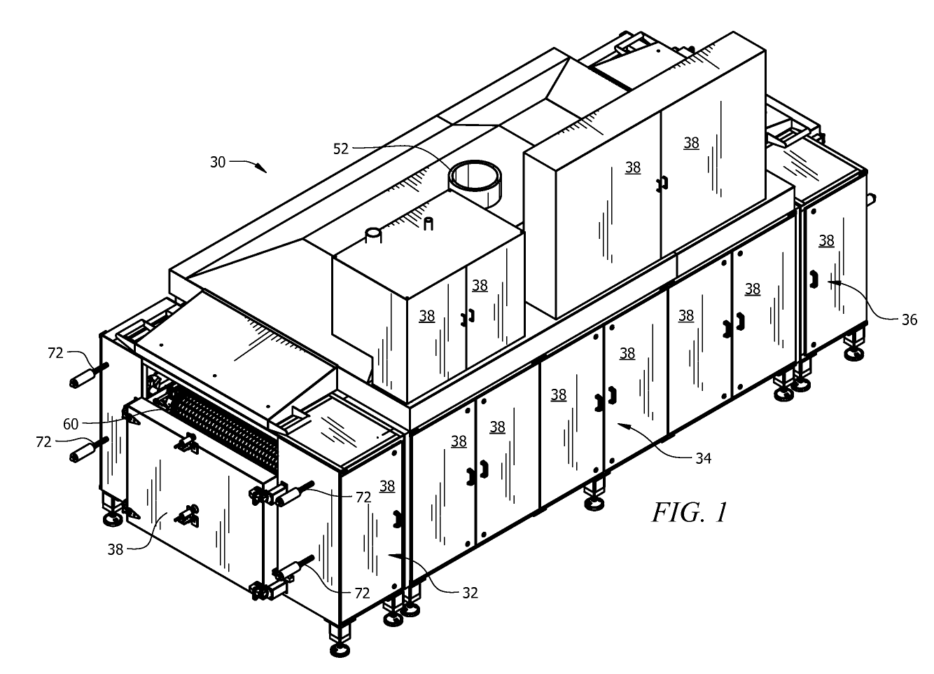

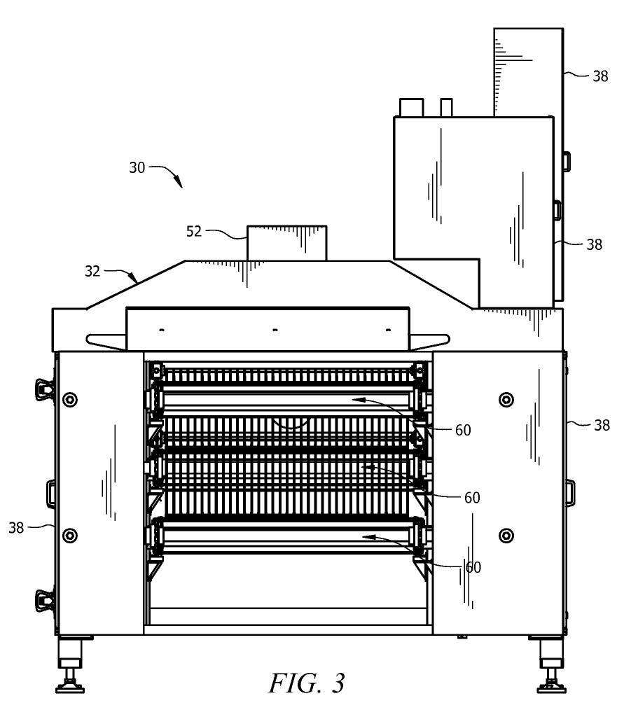

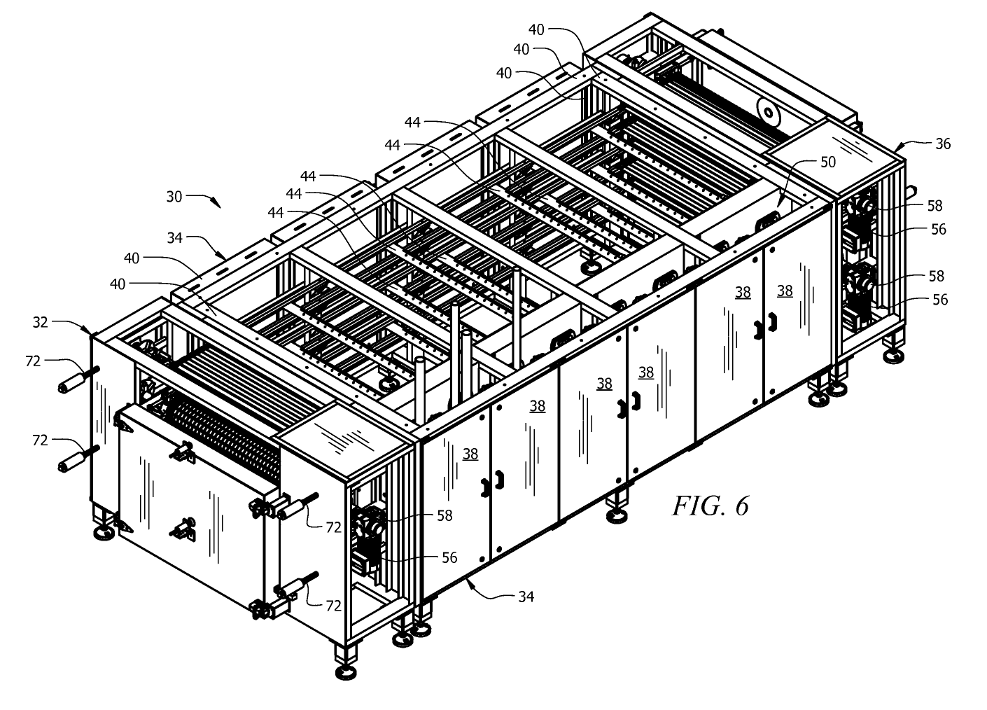

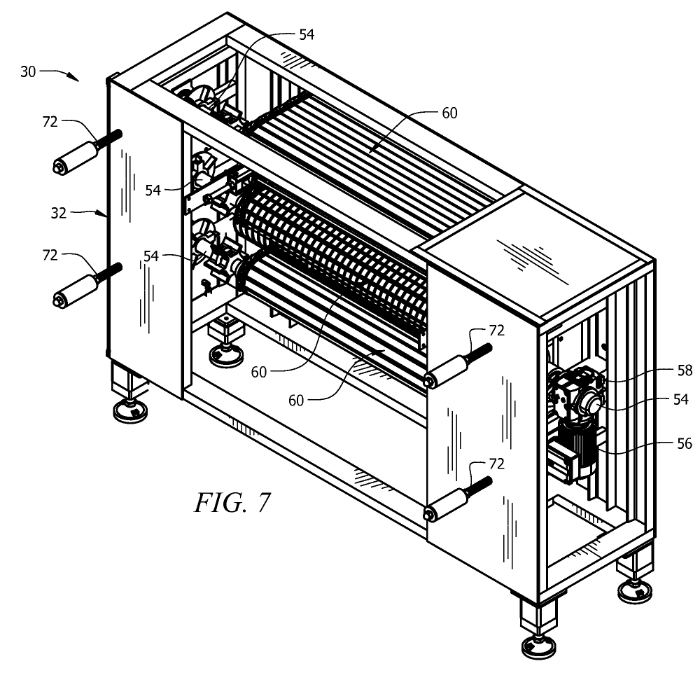

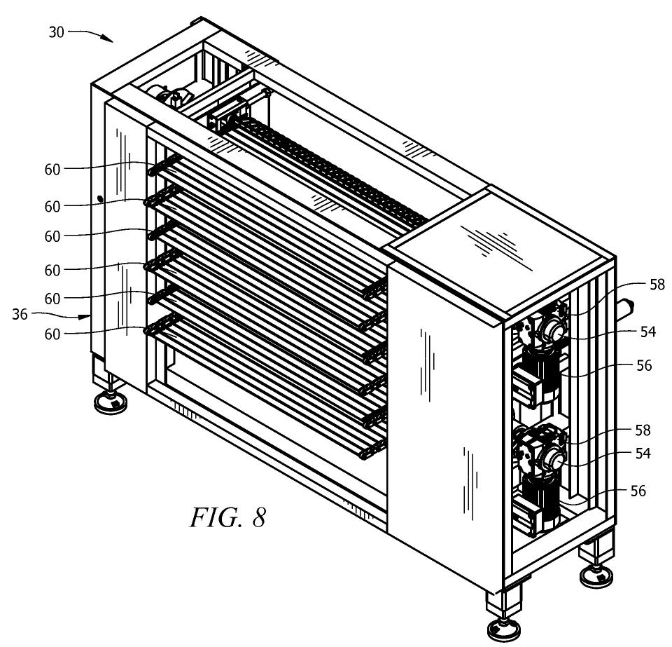

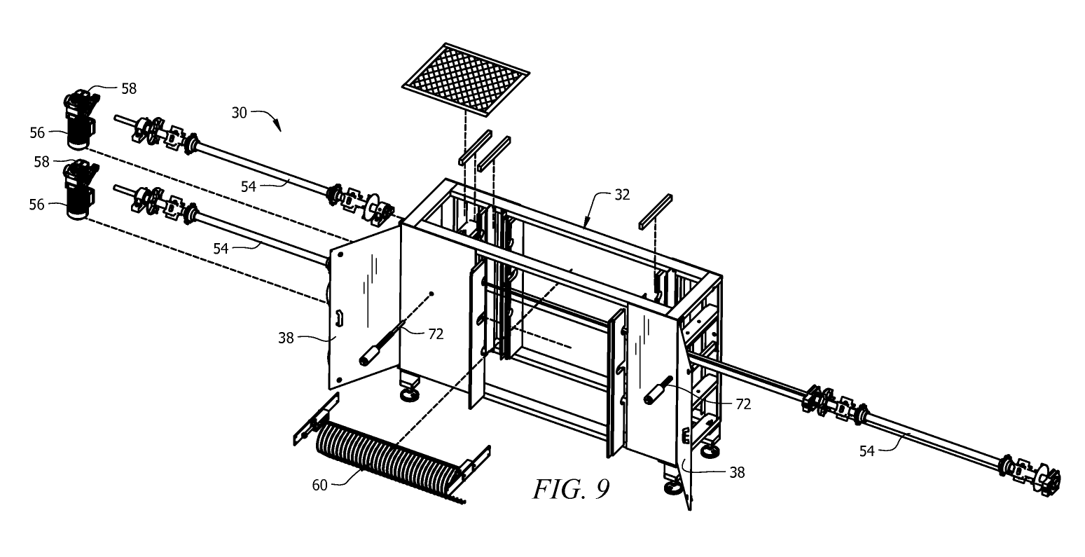

FIGS. 1-26 inclusive illustrate the construction and operation of a tortilla oven 30 comprising the present invention. Referring particularly to FIGS. 1-9 the tortilla oven 30 comprises an input section 32; a baking section 34, and a discharge section 36 which are normally secured one to another by appropriate fasteners. Each of the sections 32, 34, and 36 comprises a plurality of doors 38 which enclose and protect the component parts of the tortilla oven 30 while affording access thereto.

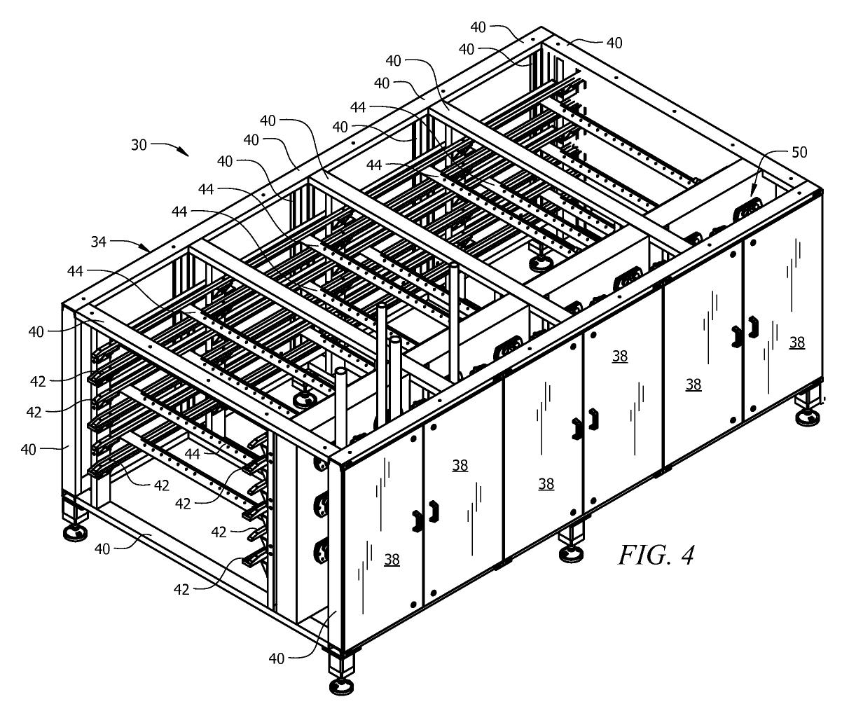

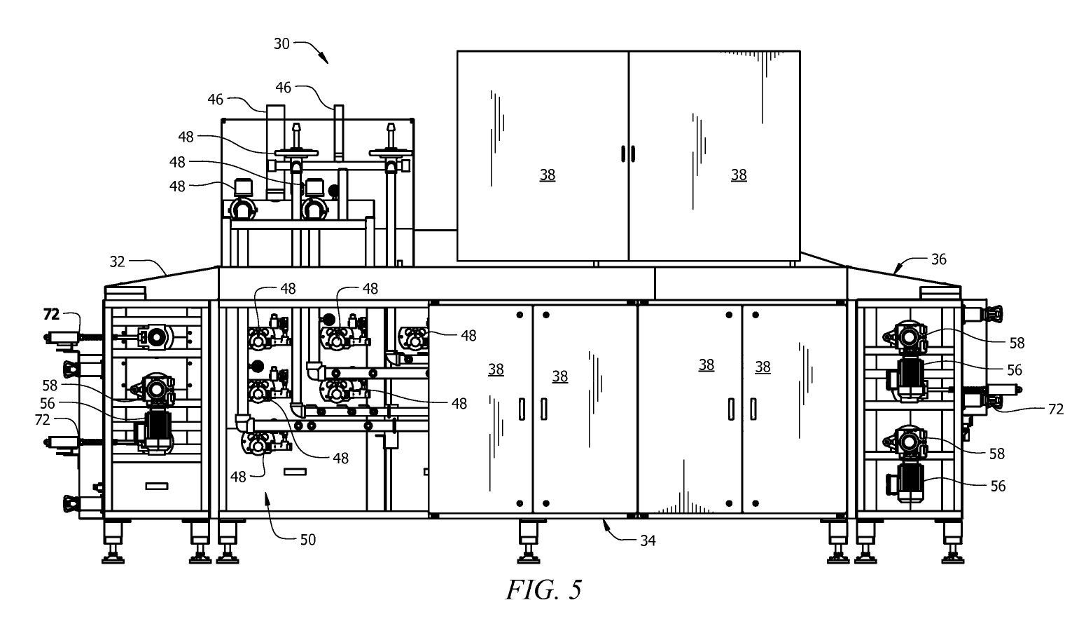

Referring particularly to FIGS. 4-6 inclusive the construction of the baking section 34 of the tortilla oven 30 is shown in detail. The baking section 34 includes a plurality of structural components 40 which support a plurality of chain guiding tracks 42. The baking section 34 further comprises the plurality of burners 44. The burners 44 receive a mixture of a selected fuel, typically natural gas, and a selected oxidizer, typically air, which are directed into the baking section 34 through a plurality of pipes 46. As is best shown FIG. 5, the flow of the fuel and oxides into the burners 44 is controlled by a plurality of regulators 48. The regulators are situated in a compartment 50 which extends along one side of the baking section 34 and is accessible by opening the doors 38. The operation of the burners 44 results in gasious products of combustion which are removed from the baking section 34 through an outlet 52 (FIGS. 1, 2, and 3).

The inlet section 32 and the outlet section 36 of the tortilla oven 30 are illustrated in FIGS. 7 and 8, respectively. The inlet section 32 and the outlet section 36 each comprise a plurality of drive shafts 54. Each of the drive shafts 54 is driven by a drive motor 56 operating through a right angle drive 58. The drive shafts 54 define the paths of three chain conveyers 60 which transport tortillas through the tortilla oven 30 during baking thereof. Those skilled in the art will appreciate the fact that the chain conveyors are driven at both ends of the there respective courses by the drive motors 56 and the right angle drive 58 connected thereto.

The constructed and operation of the tortilla oven 30 further illustrated in FIGS. 10A, 10B, 10C, 10D, and 11. Uncooked tortillas are received in the tortilla oven 30 at location 62. The tortillas are transported from location 62 along a horizontal plane by the upper conveyer 60. When the tortilla has reached the end of the upper conveyor 60 they are directed on to the center conveyor 60 by a chute 64. The center conveyor transports the tortillas along a horizontal plane to the remote end thereof where the tortillas are discharged onto the lower conveyor 60 by a chute 66. The lower conveyer 60 transports the tortillas along a horizontal plane until the fully baked tortillas are ultimately discharged from the tortilla oven 30 at location 68. A plurality of drawers 70 are located just below the lower conveyor 60. The drawers 70 receive broken tortillas and other debris resulting from operation of the tortilla oven 30. As is best shown in FIG. 11 the drawers 70 are fully insulated thereby preventing heat loss from the tortilla oven 30 through the bottom thereof.

Referring simultaneously to FIGS. 10A and 10B a rod 72 is operably connected to one of the drive shafts 54 comprising each of the conveyors 60 for movement there with as the tension within the associated conveyor 60 increases or decreases. A sensor 74 monitors the positioning of the rod 72 relative to adjacent frame component 40 of the tortilla oven 30. When the positioning of the rod 72 moves beyond a predetermined limit the sensor 74 sends an alarm signal to the operator of the tortilla oven 30 whereupon the tension of the conveyor 60 associated with the sensor 74 that generated the alarm can be appropriately adjusted.

Referring to FIG. 10C, in lieu of the sensor 74 which measures displacement a load cell 76 can be employed to directly measure the force that is applied to a particular conveyor chain 60 during operation thereof. When the load cell 74 senses a force that is beyond predetermined limits the operator of the tortilla oven 30 is notified so that appropriate adjustments to the operational parameters of the conveyor which triggered the signal from the load cell 76 can be made.

An alternative version of the tortilla 30 is illustrated in FIG. 10D. In accordance with the alternative version of the tortilla oven 30 a wall or floor 78 is positioned between the center conveyor chain 60 and the lower conveyor chain 60. Although the deployment of burners 44 between the upper and lower runs of the upper conveyor chain 60 and the upper and lower runs of the center conveyor chain 60 is the same manner as illustrated in FIG. 10A, the lower conveyor chain 60 of FIG. 10D is not provided with burners 44. The function of the wall 78 is to isolate the non-heated lower portion of the tortilla oven 30 from the heated upper portion thereof. Thus, in the operation of the embodiment of the conveyor oven 30 shown in FIG. 10D the lower conveyor chain functions to begin the cooling of fully baked tortillas after they have made two passes through the tortilla oven 30 by means of the upper conveyor chain 60 and the center conveyor chain 60. Otherwise the construction and operation of the embodiment of the tortilla oven 30 as illustrated in FIG. 10D is identical to that of the operation of the tortilla oven 30 illustrated in FIG. 10A and described hereinabove in conjunction therewith.

The construction of the conveyor chain 60 comprising the tortilla oven 30 is illustrated in FIG. 12. The conveyor chain 60 comprises stainless steel bushings 80 and stainless steel, pins 82. The plates 84, the rollers 86 and the plates 88 comprise carbon steel.

The construction and operation of the drive shafts 54 comprising the tortilla oven 30 is further illustrated in FIGS. 13-20 inclusive. The rods 72 extend from bearing blocks 90 which rotatably support the drive shafts 54. As shown in FIG. 14 the bearing blocks 90 have sideways 92 formed intervally therewith. The sideways 92 engaged guides 94 thereby facilitating longitudinal movement of the drive shafts 54 as the conveyor chains 60 driven thereby expend and contract depending upon the temperature within the tortilla oven 30.

The drive shafts 54 comprise sprockets 96 which engage and drive the conveyor chains 60. Referring particularly to FIGS. 16 and 17 portions 98 of the drive shafts 54 located between the sprockets 96 and the sideways 92 have holes 100 drilled thereto to limit heat transfer axially along the lengths of the drive shafts 54. The portions of the drive shafts 54 having the holes 100 drilled thereto are reinforced with rings 102 which are in turn provided with heat dissipating fins 104. In this manner the elevated temperatures of the sections of the drive shafts 54 extending between the sprockets 96 which occurred during operation of the tortilla oven 30 are not transferred to the bearings located within the bearing blocks 90 which locatably are rotatably support the drive shafts 54. Fans 106 mounted on the drive shafts between the portions 98 thereof having the holes 100 drilled thereto and the bearing blocks 90 further limit heat transfer from the center sections of the drive shafts 54 to the end portions thereof and to the bearings which rotatably support the drive shafts 54.

The construction and operation of the dive shafts 54 of the tortilla oven 30 are further illustrated in FIGS. 18, 19, and 20. Each drive shaft 54 is actuated by a drive motor 108. As is shown in FIG. 20, bearings 110 comprising the bearing blocks 90 are provided with half dog connections 112 which accommodate thermal expansion of the drive shaft 54 in the axial direction. The sections 98 of the drive shafts having the holes 100 have sections thermal insulated materials 112 extending on either side thereof.

FIGS. 21, 22, and 23 further illustrate the operation of the burners 54 of the tortilla oven 30 Gas is fed into the tortilla oven 30 through pipes 116. Air is fed into the burners 54 though pipes 118. The gas and the air are premixed and are directed through a feed control system which individually monitors every burner flame for flame management. This is advantageous in reducing the risk of down time because Individual burner failure and burner flame outs can be prevented. Each burner can be individually shut off through the control system for flame profile adjustment. The control system also facilitates management of each of the three zones in the system for energy output.

Referring to FIG. 24, atmospheric air is directed along the sides of the baking section 34 of the tortilla oven 30 for purposes of temperature control and to minimize heat transfer into the interior of the building 120 which houses the tortilla oven 30. The temperature controlling air moves upwardly through passageways 122 as indicated by the arrows 124. Products of combustion resulting from operation of the tortilla oven 30 move upwardly through the outlet 52 as indicated by the arrows 126. The air moving upwardly through the passageways 122 and the products of combustion moving upwardly through the outlet 52 are combined by a fan 128 and are discharged to the atmosphere through an outlet 130 extending the roof 132 of the building 120.

FIG. 25 illustrates a system for monitoring the temperature of individual conveyor chains 60 comprising the tortilla oven 30. It has been determined that continuous monitoring of the temperature of the chain produces a an inaccurate result due primarily to erroneous readings which occur when the gaps in the conveyor chain come into the alignment with the temperature sensor. In accordance with the present invention a sensor 134 recognizes the presence of a rivet 136 comprising the conveyor change 60. Whenever a rivet 136 is detected by the sensor 134 a plate 88 (see FIG. 12) is aligned with a sensor 138. Responsive to a signal from the sensor 134 the sensor 138 takes a virtually instantaneously reading which is not distorted due to the presence of a gap between the plates 88 coming into alignment with the beam of the sensor 138. Operation of the temperature sensor system illustrated in FIG. 25 is further described in the flow chart comprising FIG. 26.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A tortilla oven comprising:
a housing;
three conveyors mounted within the housing in a vertical array and comprising uppers center, and lower conveyors for transporting tortillas through the oven during baking thereof;
each of the conveyors comprising drive shifts at the opposite ends thereof;
each of the drive shafts including means for preventing heat transfer axially along the length of the drive shaft;
a plurality of burners mounted with the housing and extending through the conveyors for heating the interior of the housing;
means for individually monitoring and regulating the operation of the each burner independently of the other burners comprising the plurality thereof;
means for individually monitoring the response of the each of the three conveyors to the temperature withing the housing;
means for individually monitoring the operating temperature of each conveyor;
means for causing ambient air to flow upwardly though the housing and adjacent to the three conveyors mounted therein and thereby regulating the temperature withing the housing.
